(19) United States
(12) Patent Application Publication
(10) Pub. No.: US 2002/0162936 A1
(43) Pub. Date: Nov. 7, 2002

(54) GUIDE BAR ADAPTER, AND A GUIDE BAR ASSEMBLY

(75) Inventors: JOHN MELLARDO, TRUMBULL, CT (US); ROBERT L. DEILUS, NEWTOWN, CT (US)

Correspondence Address: MENOTTI J LOMBARDI, ITT FLUID TECHNOLOGY, 10 MOUNTAINVIEW ROAD, UPPER SADDLE RIVER, NJ, 07458

(73) Assignee: ARTHUR L. PLEVY, ESQ

(21) Appl. No.: 09/294,573

(22) Filed: Apr. 20, 1999

(51) Int. Cl. F16M 13/00

(52) U.S. Cl. 248/562

(57) ABSTRACT

A multi-section, square tube guide bar assembly, incorporates an intermediate adapter which is resiliently engaged with guide bar sections, to form a firm, tight, aligned and rugged guide bar assembly. The intermediate adapter has a plurality of splayed leaf springs in which the spring ends are tapered and inwardly inclined to facilitate the adapter engagement with the guide bar sections.

### BACKGROUND OF THE INVENTION

This invention pertains to guide bars and adapters therefor which are used for guiding submersible mixers in translation in liquids-holding tanks.

Submersible mixers are used in liquids-holding tanks to prevent sedimentation of the solids in the liquid, and to keep the liquids homogeneous. A typical mixer used today is a submersible unit comprising an electric motor, an impeller, and a drive train joining the motor and impeller. The unit has a slidable bracket which engages a guide bar, in order that the unit may be lowered into a subject liquids-holding tank, and for raising of the unit from the tank for service or replacement. The guide bar, in the prior art, consists of square tubing which is held in place, in the subject tank, by upper, lower, and intermediate guide bar adapters. During operation of the mixers, considerable torsion and thrust loads are imposed on the guide bar and its mounting adapters. Problems with the fit of the aforesaid intermediate adapter to the guide bar, and an increased amount of vibration, warranted an improvement to the known arrangements. What has been desired is a guide bar assembly, and an intermediate guide bar adapter for use in the aforesaid assembly, which exhibit a sure, snug fit together, to obviate the noted problems, eliminating unwarranted movement therebetween, with the juncture points of the assembly and the incorporated guide bar adapter smoothly mating and flush.

It is an object of this invention to disclose a guide bar assembly, and a guide bar adapter therefor, which meet the desired improvement, insure against a loose ill-matched fit, minimize vibration, and simplify assembly and disassembly of the guide bar assembly and the mating guide bar adapter.

### SUMMARY OF THE INVENTION

It is particularly an object of this invention to set forth a guide bar adapter, for use in a guide bar assembly, comprising a body; and means projecting from said body, for resiliently coupling together guide bar sections. It is also another object of this invention to disclose a guide bar assembly, comprising a first guide bar section; a second guide bar section; and means (a) in penetration of, and (b) resiliently coupling together, said sections. Further objects of this invention, as well as the novel features thereof, will become apparent by reference to the following description, taken in conjunction with the accompanying figures.

### BRIEF DESCRIPTION OF THE FIGURES

FIG. 1 is an exploded and perspective view of a prior art guide bar assembly; and

FIG. 2 is an exploded and perspective illustration of an intermediate guide bar adapter, according to an embodiment of the invention.

### DETAILED DESCRIPTION OF THE PREFERRED EMBODIMENTS

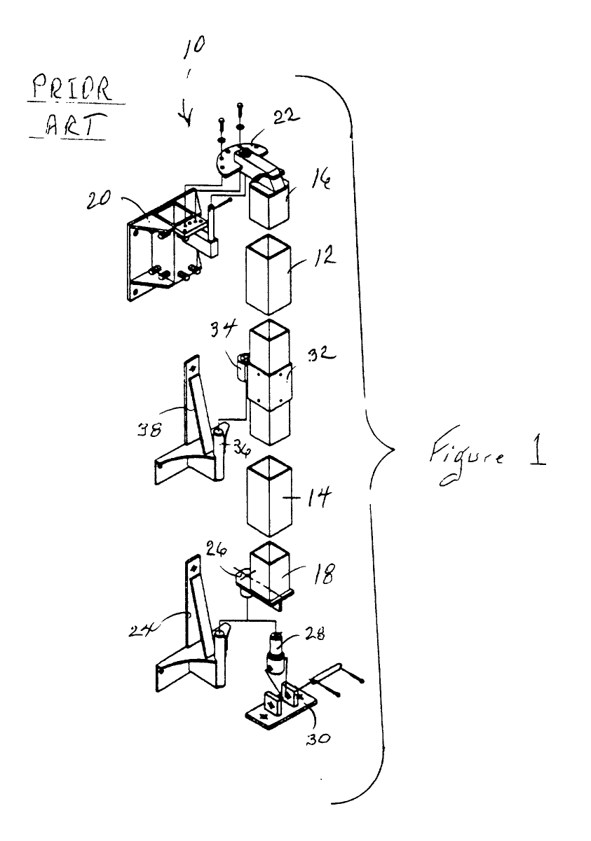

The prior ar guide bar assembly 10 illustrated in FIG. 1 shows guide bar sections 12 and 14 which make telescoping fits with an upper square socket 16 and a lower square socket 18, respectively. Socket 16 mates with an upper anchorage 20, via a mounting piece 22. Similarly, the lower socket 18 is mounted to a lower anchorage 24 via its mounting piece 26 and mating components 28 and 30.

Upper anchorage 20 is provided for fixing in an upper portion of a liquids-holding tank (not shown), against a peripheral wall thereof, and lower anchorage 24 is provided for fixing to the aforesaid wall at the bottom of such a tank. An intermediate guide bar adapter 32 telescopingly mates with sections 12 and 14, and has a trunnion 34 which rotatably engages an upstanding rod 36 which is part of an intermediate wall anchor 38.

The square tube sections 12 and 14, together with complementary square tube sockets 16 and 18, with the likewise square tube intermediate guide bar adapter 32, all constitute a guide bar assembly. The assembly slidably receives a mixer, the aforementioned motor, impeller, drive train and bracket, as a unit, the bracket effecting a slidable engagement with, for travel along, the guide bar assembly. The mixer components recited are not shown, as they are well known in this art, and are not germane to the instant invention.

It is the fit of the intermediate guide bar adapter 32 with the guide bar sections 12 and 14 which exhibits problems. The simple, telescoping fit and engagement has proved inadequate.

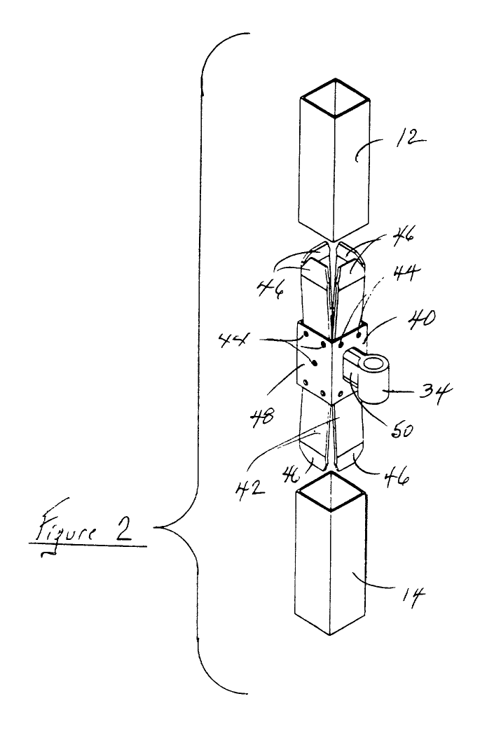

FIG. 2 depicts an embodiment of an intermediate guide bar adapter 40, according to the invention. Adapter 40 is shown in association with the square tube guide bar sections 12 and 14. Adapter 40, as can be seen, has a plurality of leaf springs 42 confined within, the same being fastened to the inner walls of the adapter by spot welds 44. The leaf springs 42 are splayed, but the terminal portions 46 thereof are tapered and inclined toward the center of the adapter 40. Upon the leaf springs 42 being pressed into the guide bar sections 12 and 14, the axial centerlines of the adapter 40 and the sections 12 and 14 are forced into correct, common alignment. The springs 42 resiliently and forcefully nest in the guide bar sections 12 and 14, and bring the mating edges of the adapter 40 and the sections 12 and 14 exactly flush. This adapter 40, by replacing the adapter 32 of FIG. 1, provides a firm, tight, aligned and rugged guide bar assembly.

Novel adapter 40 has a same trunnion 34, fixed to the body 48 by means of a stub shaft 50, for rotatable engagement with the upstanding rod 36 of FIG. 1.

The adapter 40 requires no special tools for installation and/or removal, as a simple mallet serves the purpose, The leaf springs 42 are splayed, to insure a sure grip thereof within the center of the body 48, while the taper and inward inclination of the ends thereof facilitate the mating of the adapter 40 with the guide bar sections 12 and 14. A guide bar assembly, configured with the novel adapter 40 has been found eminently capable of withstanding thrust and torsion loads created by powerful mixers, and exhibits a minimum of vibration.

While we have described our invention in connection with specific embodiments of a guide bar assembly and a guide bar adapter, it is to be clearly understood that this is done only by way of example, and not as a limitation to the scope of the invention, as set forth in the objects thereof and in the appended claims.

We claim:

1. A guide bar adapter, comprising:
a body; and
means, projecting from said body, for resiliently coupling together guide bar sections.

2. A guide bar adapter, according to claim 1, wherein:
said body has a hollow center; and
said means are partially confined within said center.

3. A guide bar adapter, according to claim 1, wherein:
said means are fastened in said body.

4. A guide bar adapter, according to claim 1, wherein:
said means comprises a plurality of leaf springs.

5. A guide bar adapter, according to claim 4, wherein:
portions of said leaf springs extend from opposite ends of said body; and
said portions of said leaf springs are splayed.

6. A guide bar adapter, according to claim 4, wherein:
terminal ends of said portions are (a) tapered, and (b) inclined toward said center.

7. A guide bar adapter, according to claim 1, further including:
a trunnion; and
a stub shaft coupling said trunnion to said body.

8. A guide bar assembly, comprising:
a first guide bar section;
a second guide bar section; and
means (a) in penetration of, and (b) resiliently coupling together, said sections.

9. A guide bar assembly, according to claim 8, wherein:
said means comprises a guide bar adapter;
said adapter has a body;
said body has a hollow center; and
said adapter further comprises a plurality of leaf springs fastened in said body.

10. A guide bar assembly, according to claim 9, wherein:
portions of said leaf springs extend from opposite ends of said body; and
said leaf spring portions are splayed.

11. A guide bar assembly, according to claim 10, wherein:
terminal ends of said portions are tapered.

12. A guide bar assembly, according to claim 10, wherein:
terminal ends of said portions are inclined toward said center.

13. A guide bar assembly, according to claim 8, wherein:
said means comprises means for coupling said guide bar assembly to an anchorage.

14. A guide bar assembly, according to claim 9, further including:
a trunnion; and
a stub shaft coupling said trunnion to said body.
